(19) United States
(12) Patent Application Publication
(10) Pub. No.: US 2010/0066672 A1
(43) Pub. Date: Mar. 18, 2010

(54) METHOD AND APPARATUS FOR MOBILE COMMUNICATION DEVICE OPTICAL USER INTERFACE

(75) Inventors: John Kevin Schoolcraft, Sanford, NC (US); Thomas David Snyder, Cary, NC (US); Daniel Van Epps, Apex, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB, Lund (SE)

(21) Appl. No.: 12/210,704

(22) Filed: Sep. 15, 2008

(51) Int. Cl. G09G 5/08; G06F 3/033

(52) U.S. Cl. 345/158; 345/157; 455/566; 455/556.1

(57) ABSTRACT

An optical user interface is provided in a mobile communication device. Motion of an input mechanism of the mobile communication device is detected via an optical sensor. In response to detection, one or more properties governing the motion are evaluated based on input from a motion sensor. Control information is generated based on evaluation.

### BACKGROUND

The present disclosure relates to mobile communication devices, more particularly to mobile communication device optical user interfaces.

Mobile communication devices, such as cellular phones, laptop computers, pagers, personal digital assistants (PDA), and the like, have become increasingly prevalent. These devices provide the convenience of handheld communications with increased functionality. For example, an expanding variety of features and applications have become available that, in addition to conventional voice communication capabilities, permit users to connect to a variety of information and media resources, such as the Internet, as well as enable users to send and receive short or multimedia messages, engage in multimedia playback, exchange electronic mail, perform audio-video capturing, participate in interactive gaming, manipulate data, browse the web, and perform or engage in other like functions or applications. Still further, these functions and applications may, at times, be concurrently accessed or even toggled between.

Unfortunately, as the richness and complexity of these functions and applications increase, the complexity of the user interface has increased commensurately. For example, mobile communication devices have been developed in a variety of configurations to include varied input mechanisms, such as automated handwriting inputs, keyboard inputs, pointing device (e.g., pen or stylus) inputs, etc. As such, it has become an increasingly greater challenge for users to interface with these conventional input mechanisms, particularly as the size of these controls and the mobile communication devices themselves continue to shrink and become more compact. Compounding this plight is the fact that certain input mechanisms, such as keyboards, are often designed for dual functions. For instance, certain keys (or buttons) may be used in one instance for entering alphanumeric characters and, in another instance, for inputting joystick-like movements, e.g., up, down, left, right, etc., which can be particularly cumbersome and rather inconvenient for users. All in all, traditional input mechanisms are becoming less capable to meet the demands of user interactivity, especially in the communication device gaming arena. Accordingly, convenient, easy to manipulate user interfaces that are at the same time compact, continue to be objectives for improvement.

Therefore, a need exists for improved mobile communication device user interfaces.

### DISCLOSURE

The above described needs are fulfilled, at least in part, by detecting motion of an input mechanism of a mobile communication device via an optical sensor. In response to detection, one or more properties governing the motion are evaluated based on input from a motion sensor. Control information is generated based on evaluation.

A mobile communication device is provided including an input mechanism, a motion sensor, an optical sensor, and a processor. The optical sensor is configured to detect motion of the input mechanism. The processor is configured to evaluate, in response to detection, one or more properties governing the motion based on input from the motion sensor, and to generate control information based on evaluation.

Still other aspects, features, and advantages are readily apparent from the following detailed description, wherein a number of particular embodiments and implementations, including the best mode contemplated, are shown and described. The disclosure is capable of other and different embodiments, and its several details are capable of modifications in various obvious respects, all without departing from the spirit and scope of the disclosure. Accordingly, the drawings and description are to be regarded as illustrative in nature, and not as restrictive.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a block diagram of a mobile communication device, according to an exemplary embodiment;

FIGS. 2-4 are schematic diagrams of optical input mechanisms of the mobile communication device of FIG. 1, according to exemplary embodiments;

FIG. 5 is a schematic diagram of a mobile phone including one or more optical input mechanisms, according to an exemplary embodiment;

FIGS. 6A and 6B are flowcharts of processes for controlling a function or updating a display of the mobile communication device of FIG. 1 based on motion of an optical input mechanism, according to exemplary embodiments;

FIG. 7 is a flowchart of a process for generating control information based on motion of an optical input mechanism, according to an exemplary embodiment; and

FIG. 8 is a flowchart of a process for transmitting control information to another device based on motion of an optical input mechanism, according to an exemplary embodiment.

### DETAILED DESCRIPTION

An apparatus, method, and software for providing mobile communication device optical user interfaces are disclosed. In the following description, for the purposes of explanation, numerous specific details are set forth in order to provide a thorough understanding of exemplary embodiments. It is apparent, however, to one skilled in the art that exemplary embodiments may be practiced without these specific details or with an equivalent arrangement. In other instances, well-known structures and devices are shown in block diagram form in order to avoid unnecessarily obscuring exemplary embodiments.

Although exemplary embodiments are described with respect to mobile communication devices, it is recognized that various exemplary embodiments have applicability to other devices and technologies.

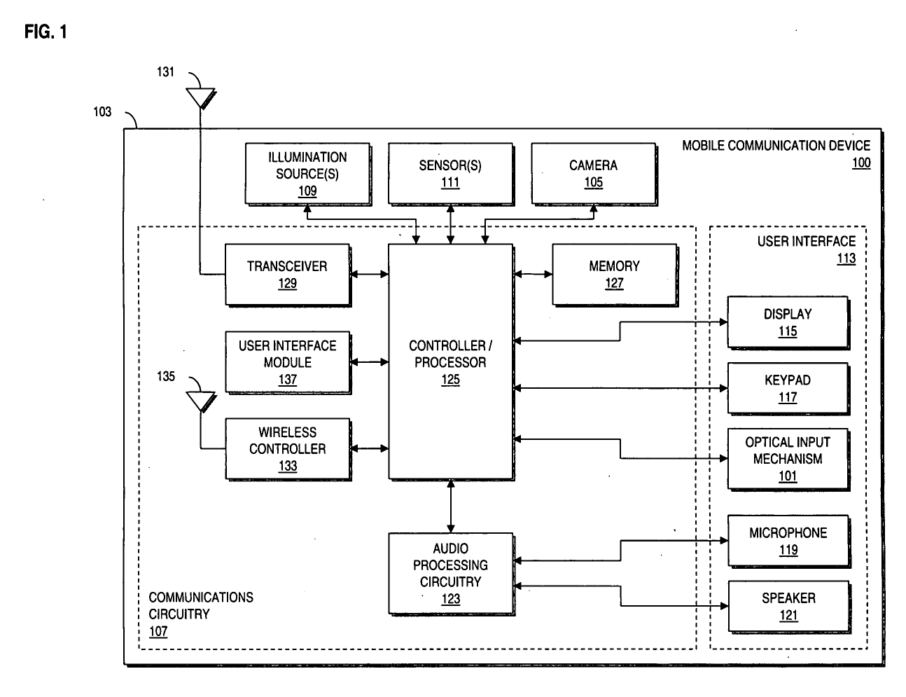

FIG. 1 is a block diagram of a mobile communication device, according to an exemplary embodiment. Mobile communication device 100 includes one or more optical input mechanisms 101 that facilitate and engender user interactivity by providing users with joystick-like and/or mouse-like functionalities. Joystick-like and mouse-like control interfaces provide quick, convenient means for users to easily navigate menu options, scroll through browser applications, manipulate or rollover graphical user interface (GUI) components (e.g., cursors, widgets, etc.), perform drag and drop commands, control remote devices, and the like. Conventional joystick and mouse interfaces are, however, relatively bulky and intricate, which makes these devices unsuitable for mobile communication device implementations. Thus, the optical input mechanism(s) 101 of mobile communication device 100 are configured to provide joystick-like and/or mouse-like functionality within compact, sleek mobile communication device profiles. As such, it is contemplated that optical input mechanism(s) 101 can be embodied by one or more hardware components, as well as implemented via application software or executable code that resides in and is executed by mobile communication device 100.

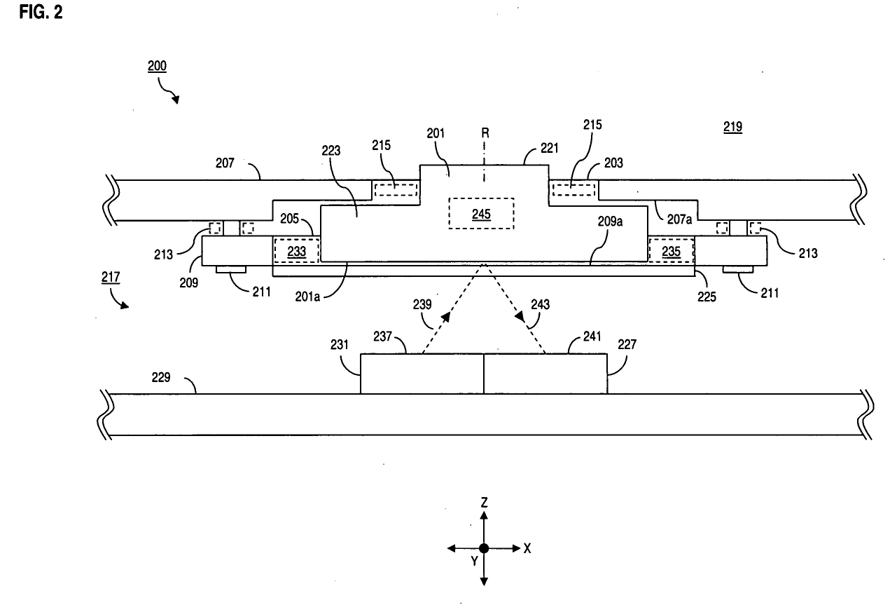

Optical input mechanisms 101 are described in more detail in accordance with FIGS. 2-4. However, still referring to FIG. 1, mobile communication device 100 can be, in exemplary embodiments, a mobile phone, which may be provided in any suitable housing (or casing) 103, such as a brick (or candy bar) housing, a fold (or clamshell) housing, slide housing, swivel housing, and/or the like. In this example, mobile communication device 100 includes camera 105, communications circuitry 107, one or more illumination sources 109, one or more sensors 111, and user interface 113. While specific reference will be made thereto, it is contemplated that mobile communication device 100 may embody many forms and include multiple and/or alternative components.

User interface 113 includes one or more of the following: display 115, keypad 117, microphone 119, optical input mechanism 101, and/or transducer (or speaker) 121. Display 115 provides a graphical interface that permits a user of mobile communication device 100 to view call status, configurable features, contact information, dialed digits, directory addresses, menu options, operating states, time, and other information, such as optical input mechanism settings for extending the optical input functionalities to users. The graphical interface may include icons and menus, as well as other text, soft controls, symbols, and/or widgets. In this manner, display 115 enables users to perceive and interact with the various features of mobile communication device 100.

Keypad 117 may be a conventional input mechanism. That is, keypad 117 may provide for a variety of user input operations. For example, keypad 117 may include alphanumeric keys for permitting entry of alphanumeric information, such as contact information, configuration parameters, directory addresses, notes, phone lists, etc. In addition, keypad 117 may represent other input controls, such as button controls, dials, and the like. Various portions of keypad 117 may be utilized for different functions of mobile communication device 100, such as for conducting voice communications, short messaging, multimedia messaging, playing interactive games, etc. Keypad 117 may include a “send” key for initiating or answering received communication sessions, and an “end” key for ending or terminating communication sessions. Special function keys may also include menu navigation keys, for example, for navigating through one or more menus presented via display 115, to select different mobile communication device functions, profiles, settings, etc. Other keys associated with mobile communication device 100 may include a volume key, an audio mute key, an on/off power key, a web browser launch key, a camera key, etc. Keys or key-like functionality may also be embodied through a touch screen and associated soft controls presented via display 115.

Microphone 119 converts spoken utterances of a user into electronic audio signals, while speaker 121 converts audio signals into audible sounds. Microphone 119 and speaker 121 may operate as parts of a voice (or speech) recognition system. Thus, a user, via user interface 113, can construct user profiles, enter commands, generate user-defined policies, initialize applications, input information, manipulate screen indicia (e.g., cursors), select options from various menu systems, and the like.

Communications circuitry 107 enables mobile communication device 100 to initiate, receive, process, and terminate various forms of communications, such as voice communications (e.g., phone calls), short message service (SMS) messages (e.g., text and picture messages), and multimedia message service (MMS) messages. In other instances, communications circuitry 107 enables mobile communication device 100 to transmit, receive, and process voice signals and data, such as voice communications, endtones, image files, video files, audio files, ringbacks, ringtones, streaming audio, streaming video, video game information, etc. Communications circuitry 107 includes audio processing circuitry 123, controller (or processor) 125, memory 127, transceiver 129 coupled to antenna 131, and wireless controller 133 (e.g., a short range transceiver) coupled to antenna 135.

A specific design and implementation of communications circuitry 107 can be dependent upon one or more communication networks for which mobile communication device 100 is intended to operate. For example, mobile communication device 100 may be configured for operation within any suitable wireless network utilizing, for instance, an electromagnetic (e.g., radio frequency, optical, and infrared) and/or acoustic transfer medium. In various embodiments, mobile communication device 100 (i.e., communications circuitry 107) may be configured for operation within any of a variety of data and/or voice networks, such as advanced mobile phone service (AMPS) networks, code division multiple access (CDMA) networks, general packet radio service (GPRS) networks, global system for mobile communications (GSM) networks, internet protocol multimedia subsystem (IMT) networks, personal communications service (PCS) networks, time division multiple access (TDMA) networks, universal mobile telecommunications system (UTMS) networks, or a combination thereof. Other types of data and voice networks (both separate and integrated) are also contemplated, such as microwave access (MiMAX) networks, wireless fidelity (WiFi) networks, satellite networks, and the like.

Wireless controller 133 acts as a local wireless interface, such as an infrared transceiver and/or a radio frequency adaptor (e.g., Bluetooth adapter), for establishing communication with an accessory, hands-free adapter, another mobile communication device, computer, or other suitable device or network.

Processing communication sessions may include storing and retrieving data from memory 127, executing applications to allow user interaction with data, displaying video and/or image content associated with data, broadcasting audio sounds associated with data, and the like. Accordingly, memory 127 may represent a hierarchy of memory, which may include both random access memory (RAM) and read-only memory (ROM). Computer program instructions, such as “optical input mechanism” application instructions or “optical mouse” application instructions, and corresponding data for operation, can be stored in non-volatile memory, such as erasable programmable read-only memory (EPROM), electrically erasable programmable read-only memory (EEPROM), and/or flash memory; however, may be stored in other types or forms of storage. Memory 127 may be implemented as one or more discrete devices, stacked devices, or integrated with controller (or processor) 125. Memory 127 may store program information, such as one or more user profiles, one or more user defined policies, one or more user interface control parameters, etc. In addition, system software, specific device applications, program instructions, program information, or parts thereof, may be temporarily loaded to memory 127, such as to a volatile storage device, e.g., RAM. Communication signals received by mobile communication device 100 may also be stored to memory 127, such as to a volatile storage device.

Controller 125 controls operation of mobile communication device 100 according to programs and/or data stored to memory 127, as well as based on user input received through one or more of the components of user interface 113. Control functions may be implemented in a single controller (or processor) or via multiple controllers (or processors). Suitable controllers may include, for example, both general purpose and special purpose controllers, as well as digital signal processors, local oscillators, microprocessors, and the like. Controller 125 may also be implemented as a field programmable gate array (FPGA) controller, reduced instruction set computer (RISC) processor, etc. Controller 125 may interface with audio processing circuitry 123, which provides basic analog output signals to speaker 121 and receives analog audio inputs from microphone 119.

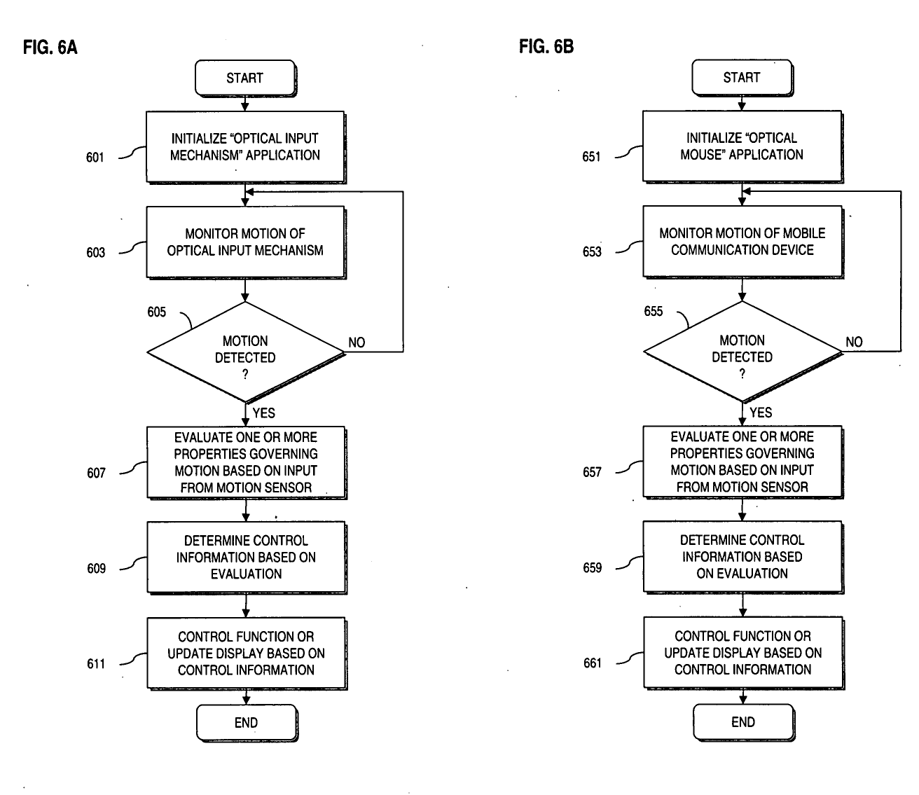

Controller 125, in addition to orchestrating various operating system functions, also enables execution of software applications, such as an “optical input mechanism” application and an “optical mouse” application stored to memory 127. A predetermined set of software applications that control basic device operations, such as voice and data communications, may be installed on mobile communication device 100 during manufacture. The “optical input mechanism” and the “optical mouse” applications may also be installed on mobile communication device 100 during manufacture, to implement exemplary embodiments described herein, such as the processes of FIGS. 6-8. It is contemplated that additional software modules may also be provided, such as a user interface module 137 for controlling one or more components of user interface 113 or implementing input/output commands to and from the components of user interface 113. Other software modules may be provided for sensing illumination or detecting motion.

Mobile communication device 100 can include one or more illumination sources 109 and/or one or more sensors 111. Illumination sources 109 may include blubs, lasers, laser diodes, light emitting diodes (LED), and the like. Sensors 107 may include various transducers, such as electroacoustic transducers (e.g., microphone, piezoelectric crystal, etc.), electromagnetic transducers (e.g., photodetector, photoresistor, hall effect sensor, optoelectronic sensor, etc.) electromechanical transducers (e.g., accelerometer, air flow sensor, load cell, strain gauge, etc.), electrostatic transducers (e.g., electrometer, etc.), thermoelectric transducers (e.g., resistance temperature detector, thermocouple, thermistor, etc.), or radioacoustic transducers (e.g., radio frequency receiver, etc.), as well as combinations thereof.

Mobile communication device 100 may also include camera 105 for capturing digital images and/or movies. This functionality may be additionally (or alternatively) provided via one or more of sensors 107, e.g., one or more photodetectors, optoelectronic sensors, etc. Image and/or video files corresponding to the captured pictures and/or movies may be stored to memory 127. According to certain embodiments, image and/or video files may be processed by controller 125 and/or user interface module 137 to detect motion (e.g., displacement, direction, speed, acceleration, etc.) of optical input mechanism(s) 101, as well as to determine corresponding control information for controlling a function of mobile communication device 100 or updating applications, control mechanisms, information, indicia, etc., presented via display 115.

While exemplary embodiments of mobile communication device 100 have been described with respect to a two-way radio frequency communication device having voice and data communication capabilities, embodiments of mobile device 100 are not so limited. For instance, mobile communication device 100 may additionally (or alternatively) correspond to any suitable wireless two-way communicator. For example, mobile communication device 100 can be a cellular phone, two-way trunked radio, combination cellular phone and personal digital assistant (PDA), smart phone, cordless phone, satellite phone, or any other suitable mobile communication device with voice and/or data communication capabilities, such as a mobile computing device.

FIGS. 2-4 are schematic diagrams of various optical input mechanisms 101 of mobile communication device 100, according to exemplary embodiments. Throughout these depictions, elements of mobile communication device 100 not necessary for description of operation of optical input mechanisms 101 are omitted for clarity of disclosure.

Referring now to FIG. 2, an exemplary optical input mechanism 200 for mobile communication device 100 is shown for providing users with joystick-like interfacing capabilities. Optical input mechanism 200 includes control member 201, i.e., a physically manipulable component of mobile communication device 100, that is adapted for actuation by a user in a planar fashion (such as translational displacement and/or rotation) within an imaginary XY-plane. For instance, translational displacement may be provided in an imaginary X-direction, an imaginary Y-direction, and/or a combination thereof. Rotational motion may be provided about an axis of rotation R extending in an imaginary Z-direction. In other instances, control member 201 may provide for “selecting” or “clicking” functions and, therefore, can be capable of translational displacement in the imaginary Z-direction. Motion of control member 201 within the imaginary XY-plane may be constrained by bore regions 203 and 205 of upper housing member 207 and support bracket 209. Meanwhile, motion in the imaginary Z-direction may be constrained by a cavity defined between corresponding surfaces 207a and 209a of upper housing member 207 and support bracket 209. One or more coupling mechanisms 211, e.g., pins, screws, stands, etc., may be provided for fixing support bracket 209 to upper housing member 207, as well as providing a predefined amount of spacing between upper housing member 207 and support bracket 209 to allow control member 201 to travel in the imaginary Z-direction. One or more sealing members 213 and/or 215 (e.g., gaskets, seals, etc.) may be provided for substantially sealing off, e.g., hermetically sealing off, an inner cavity 217 of mobile communication device 100 from surrounding environment 219, so as to prevent contaminants, e.g., dirt, grime, moisture, etc., from entering inner cavity 217. In this manner, sealing members 215 can be sufficiently elastic enough to allow control member 201 to be easily manipulated by a user; however, sufficiently rigid enough not to become dislodged from bore region 203. According to certain embodiments, sealing members 215 may be affixed to one or more outer surfaces of control member 201 and/or one or more inner surfaces of bore region 203. Other techniques to substantially seal off inner cavity 217 from surrounding environment 219 are also contemplated.

Control member 201 may be supported by support bracket 209 and, thereby, partially suspended in inner cavity region 217 of mobile communication device 100, and partially extended from upper housing member 207. An upper region 221 of control member 201 is made available for users to manipulate optical input mechanism 200 with, for example, a finger, thumb, or other extremity. A lower region 223 of control member 201 can rest against a contact surface 209a of support bracket 209. In certainly exemplary embodiments, contact surface 209a may correspond to a support bracket window 225 configured to expose a bottom surface 201a of control member 201. As will become more apparent below, bottom surface 201a of control member 201 may be colored, etched, patterned, or otherwise featured in order to facilitate motion detection via optical sensor 227 coupled to, for example, lower housing member 229 of mobile communication device 100. It is noted, however, that optical sensor 227 (and/or illumination source 231 for that matter) may be supported or suspended at an intermediary position of inner cavity region 217. It is also noted that optical sensor 227 and illumination source 231 interface with (e.g., are electronically coupled to) circuitry (not shown) of mobile communication device 100.

According to various embodiments, control member 201 can be automatically biased to a central resisting position via one or more biasing members (e.g., biasing members 233 and 235) positioned within bore 205. Biasing members 233 and 235 may include, for example, one or more spring bushings, elastic materials, piezoelectric actuators, magnetosensitive elements, etc. In exemplary embodiments, a plurality of biasing members may be arranged in equally, radially spaced apart regions of bore 205. In this manner, the plurality of biasing members (such as biasing members 233 and 235) can create equal and opposing biasing forces to balance control member 201 to a central resting position, such as the illustrated position of FIG. 2, i.e., when control member 201 is not actuated by a user. The biasing effect of the various biasing members (e.g., biasing members 233 and 235) may be further enhanced by sealing members 215.

In exemplary embodiments, motion of control member 201 may be detected by optical sensor 227 based on, for example, radiation (e.g., infrared light, ultraviolet light, visible light, etc.) cast upon surface 201a of control member 201 by illumination source 231. According to certain embodiments, illumination source 231 can have an exposure face 237 substantially facing upper housing member 207. Exposure face 237 may include one or more lens or other optical elements for acting upon, e.g., aligning, focusing, collimating, splitting, etc., the radiation cast upon surface 201a. In this manner, radiation may be output via illumination source 231 along optical path 239, which passes through window 225 of support bracket 209 and is incident upon surface 201a of control member 201. The scattering or reflection of the radiation traversing optical path 239 may be detected at exposure face 241 of optical sensor 227 via optical path 243. Optical sensor 227 may additionally (or alternatively) image surface 201a of control member 201 via the radiation detected via optical path 243. Similarly to exposure face 237 of illumination source 231, exposure face 241 of optical sensor 227 may include one or more lens or other optical elements for acting upon, e.g., aligning, focusing, collimating, splitting, etc., reflected or scattered radiation of optical path 243. It is also contemplated that optical paths 239 and 243 can include multiple optical paths, wherein, for example, interference (or other optical phenomenon) between one or more of these multiple optical paths is detected by optical sensor 227.

Thus, based on movement (e.g., translational displacement or rotational motion) of control member 201, radiation traversing optical paths 239 and 243 may be varied, such that one or more signals or images can be analyzed and or compared against one another to generate corresponding “joystick-like movement” control information by, for example, controller 125 and/or user interface module 137 for controlling a function of mobile communication device 100 or updating a presentation of display 115. In those instances when optical sensor 227 images bottom surface 201a of control member 201, two or more images, such as two or more successive images or an image and a reference image, of bottom surface 201a may be utilized by controller 125 and/or user interface module 137 to determine the “joystick-like movement” control information. Additional motion information corresponding to control member 201, such as a rate of displacement (e.g., translational acceleration, translational speed, translational velocity, etc.) or rate of rotation (e.g., rotational acceleration, rotational speed, rotational velocity, etc.), may be ascertained via one or more motion sensors 245, such as one or more accelerometers, gyroscopic sensors, microelectromechanicalsystem (MEMS) inertial devices, ultrasonic sensors, microwave sensors, vibrometers, etc. However, the rate of displacement or rate of rotation information may be ascertained via detected radiation at optical sensor 227. This “joystick-like movement” control information may be transmitted by, for example, transceiver 129 and/or wireless controller 133 to another device (not shown) for controlling a function or position of the other device and/or updating a display of the other device. Exemplary processes for sensing motion, generating control information, and/or transmitting control information are described in more detail in connection with FIGS. 6-8.

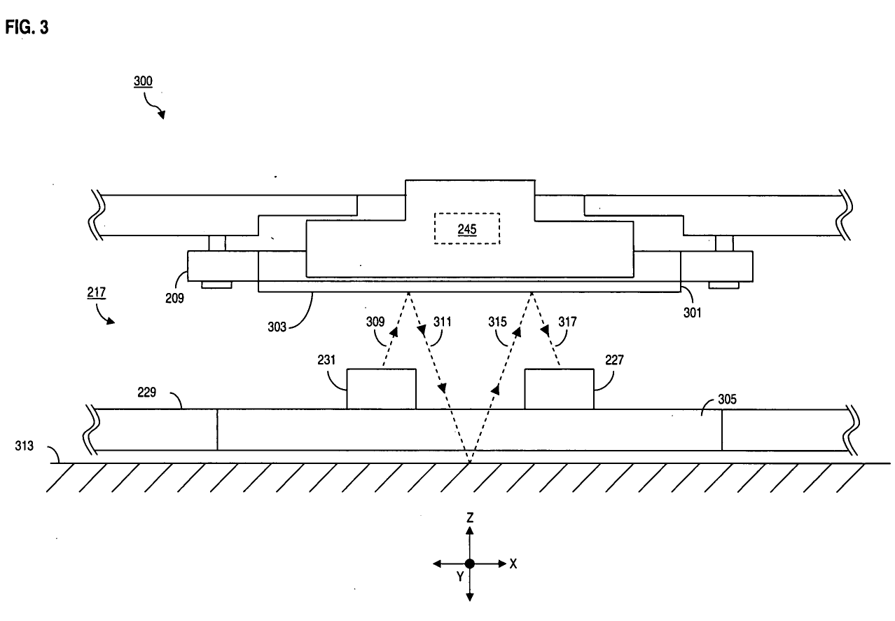

In certain embodiments, a “mouse-like” optical user interface may be provided by mobile communication device 100 via exemplary optical input mechanism 300 of FIG. 3. In this example, window 225 of support bracket 209 may be replaced or covered (such as partially covered) by a mirror 301 having a reflective surface 303 and lower housing member 229 may be provided with one or more housing windows 305 or apertures through lower housing into cavity region 217. Accordingly, when illumination source 231 irradiates reflective surface 303 of mirror 301 via optical path 309, the radiation may be reflected to optical path 311 and passed through housing window 305. Optical path 311 can radiate onto resisting surface 313 and can be scattered or reflected to optical path 315. Optical path 315 passes through housing window 305 (or another housing window or aperture of lower housing 229) and can be made incident upon reflective surface 303 of mirror 301. In this manner, optical path 315 is reflected or scattered to optical path 317 and, thereby, detected, imaged, or otherwise received via optical sensor 227. Optical paths 309, 311, 315, and/or 317 can include multiple optical paths, wherein, for example, interference (or other optical phenomenon) between one or more of these multiple optical paths is detected by optical sensor 227. Therefore, as a user moves (e.g., displaces or rotates) mobile communication device in an imaginary X-direction, an imaginary Y-direction, or combination thereof, or about an axis of rotation extending in an imaginary Z-direction, the reflection, scattering, interference, etc., of radiation produced via illumination source 231 will be altered. Based on detecting, imaging, or otherwise receiving the radiation of optical path 317, controller 125 and/or user interface module 137 may determine “mouse-like movement” control information for controlling a function of mobile communication device 100 or updating a display of display 115. When optical sensor 227 images resting surface 313, two or more images, such as two or more successive images or an image and a reference image, may be utilized by controller 125 and/or user interface module 137 to determine the “mouse-like movement” control information. Additional motion information corresponding to motion of mobile communication device 100 along or about resting surface 313, such as a rate of displacement (e.g., translational acceleration, translational speed, translational velocity, etc.) or rate of rotation (e.g., rotational acceleration, rotational speed, rotational velocity, etc.), may be ascertained via one or more motion sensors 245. However, the rate of displacement or rate of rotation information may be ascertained via detected radiation at optical sensor 227. This “mouse-like movement” control information may be transmitted by, for example, transceiver 129 and/or wireless controller 133 to another device (not shown) for controlling a function or position of the other device and/or updating a display of the other device.

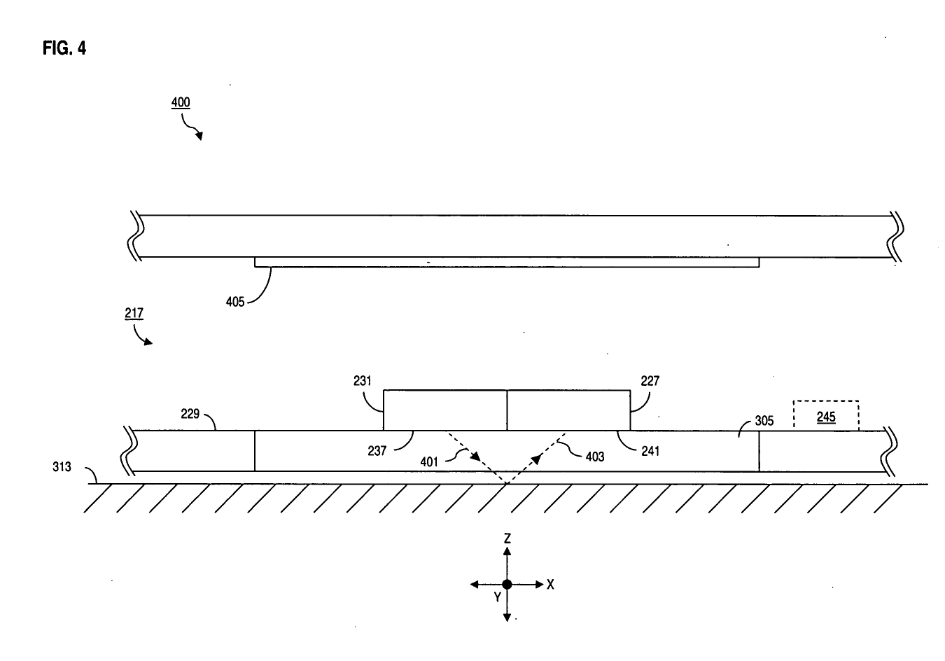

According to another exemplary embodiment, an optical input mechanism 400 of FIG. 4 may be implemented by mobile communication device 100 for providing “mouse-like” capabilities, wherein mirror 301 is not required but may be provided. In this example, illumination source 231 and optical sensor 227 can be “flipped” such that respective exposure faces 237 and 241 substantially face lower housing 229. Based on this configuration, illumination source 231 may directly irradiate resisting surface 313 via optical path 401 passing through housing window 305. Meanwhile, optical sensor 227 may detect reflection, scattering, or interference, etc., effects of optical path 401 via optical path 403 also passing through housing window 305; however, other housing windows or apertures through lower housing 225 may be utilized. It is also contemplated that optical paths 401 and 403 can include multiple optical paths, wherein, for example, interference (or other optical phenomenon) between one or more of these multiple optical paths is detected by optical sensor 227. Further, optical sensor 227 may image resisting surface 313 via radiation detected via optical path 403.

According to certain embodiments, other sources of illumination, such as backlight 405 of, for instance, display 115, keyboard 117, or other component of mobile communication device 100, may additionally (or alternatively) irradiate resisting surface 313. Additional (or alternative) sources of “other” illumination are also contemplated, such as ambient light, etc. In such instances, backlight 405 (and/or one or more of these other sources of illumination) may also illuminate inner cavity region 217 and, therefore, may be utilized as a source of illumination by optical input mechanisms 200 and 300 of FIGS. 2 and 3, respectively. While not shown, one or more optical elements, such as optical alignments, mirrors, lenses, etc., may be provided for directing and/or conditioning radiation emitted from backlight 405 (and/or one or more of the “other” sources of illumination) onto resisting surface 313, mirror 303, or bottom surface 201a of control member 201. Whether illumination is provided via illumination source 231, backlight 405, etc., radiation can propagate as needed to suit the various exemplary embodiments. For instance, whatever the source of radiation is for optical input mechanism 400, the radiation may pass through housing window 305, reflect off resisting surface 313, pass back through housing window 305 (or another housing window or aperture through lower housing member 225) and be detected, imaged, or otherwise received via optical sensor 227.

Accordingly, motion of mobile communication device 100 relative to resisting surface 313 may be detected, imaged, or otherwise received via optical sensor 227 in a similar manner as in FIG. 3; however, radiation from illumination source 231, backlight 409, etc., may traverse a more direct route to and from resting surface 313 while in route to optical sensor 227. Based on detecting, imaging, or otherwise receiving the radiation, controller 125 and/or user interface module 137 may determine “mouse-like movement” control information for controlling a function of mobile communication device 100 or updating a display of display 115. When optical sensor 227 images resting surface 313, two or more images, such as two or more successive images or an image and a reference image, of resisting surface 313 may be utilized by controller 125 and/or user interface module 137 to determine the “mouse-like movement” control information. Additional motion information corresponding to motion of mobile communication device 100 along or about resting surface 313, such as a rate of displacement (e.g., translational acceleration, translational speed, translational velocity, etc.) or rate of rotation (e.g., rotational acceleration, rotational speed, rotational velocity, etc.), may be ascertained via one or more motion sensors 245. It is contemplated, however, that the rate of displacement or rate of rotation information may be ascertained via detected radiation at optical sensor 227. It is also contemplated that this “mouse-like movement” control information may be transmitted by, for example, transceiver 129 and/or wireless controller 133 to another device (not shown) for controlling a function or position of the other device and/or updating a display of the other device. Sensation of motion, generation of control information, and/or transmission of control information is explained in more detail in association with the processes of FIGS. 6-8.

An example of a mobile communication device 100 implementing one or more of optical input mechanisms 200, 300, and/or 400 is described in relation to a mobile phone, such as a radio (e.g., cellular) phone. In the example, the mobile phone implements a graphical user interface cursor controller, which may be manipulated by users to control a function of the mobile phone, input information to the mobile phone, obtain information from the mobile, or otherwise interface with the mobile phone. It is contemplated, however, that movement of the optical input mechanisms 101 of the mobile phone may be additionally (or alternatively) utilized to control a function or position of another device, input information to the other device, obtain information from the other device, or otherwise interface with the other device.

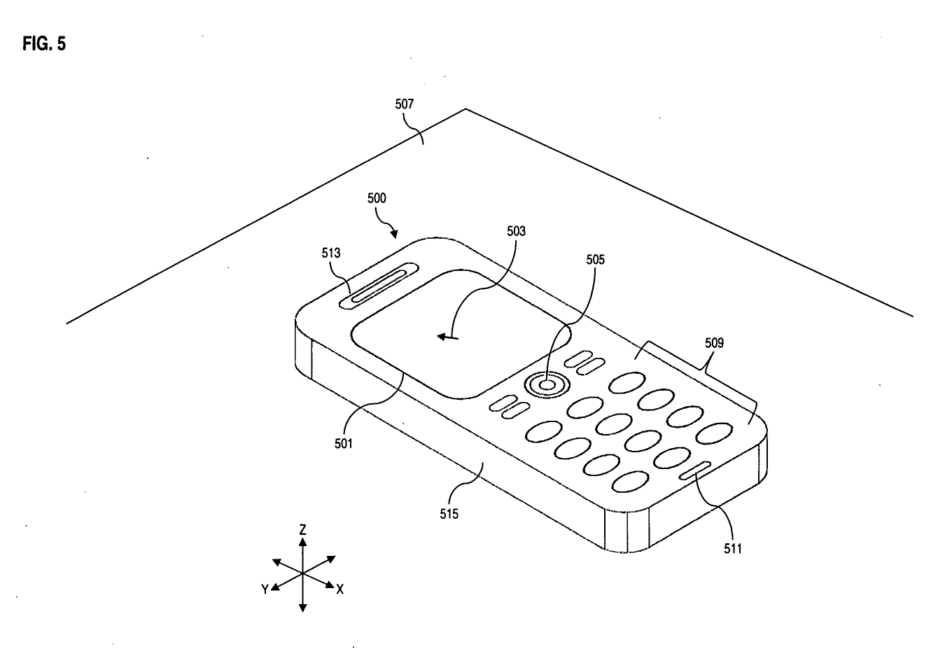

FIG. 5 is a schematic diagram of a mobile phone including one or more optical input mechanisms, according to an exemplary embodiment. Mobile phone 500 includes display 501 presenting, for example, cursor controller 503 that may be manipulated by the user actuating optical input mechanism 505 or displacing or moving mobile phone 501 along or about resisting surface 507, e.g., in an imaginary X-direction, an imaginary Y-direction, or combinations thereof, or about an axis of rotation extending in an imaginary Z-direction. In this manner, mobile phone 500 can provide one or more optical user interfaces, such as optical user interfaces 200, 300, and/or 400, to users for controlling a function of mobile phone 500 or interacting with features of mobile phone 500 via cursor controller 503. According to other embodiments, processing circuitry (not shown) of mobile phone 500 can update a position of cursor controller 503 presented via display 503 based on the direction, magnitude of displacement, rate of displacement, rotation, and/or rate of rotation of optical input mechanism 505 or mobile phone 500 along or about resisting surface 507. Users may also be provided with “selecting” or “clicking” capabilities via cursor controller 503 by, for example, depressing optical input mechanism 505 in the imaginary Z-direction or performing a predefined motion of mobile phone 500 along or about resisting surface 507. For instance, a selection may be initiated by motioning mobile phone 500 in a predetermined circular fashion, such that cursor controller 503 correspondingly circles a presented “feature” or “element” to be selected on display 501. In other instances, control functions, such as “selecting” or “clicking” capabilities, of the optical user interface may be supplemented via conventional input mechanisms, such as keyboard 509. Still further, depressing optical input mechanism 505 or “holding” a predetermined button of keyboard 509 along with translational displacement or rotational motion of optical input mechanism 505 or mobile phone 500 may be utilized to rotate indicia on or the presentation of display 503, such as rotating a three-dimensional viewpoint of a character in a video game implemented by mobile 500. Mobile phone 500 may also provide users with voice recognition and text-to-speech user interface technology via an audio interface of mobile phone 500, e.g., the conjunction of microphone 511 and speaker 513. Although housing 515 is shown providing mobile phone 500 in a brick-like (or candy bar) fashion, it is contemplated that housing 515 may provide mobile phone 500 in one or more alternative fashions, such as in a foldable (or clamshell) housing, slide housing, swivel housing, etc.

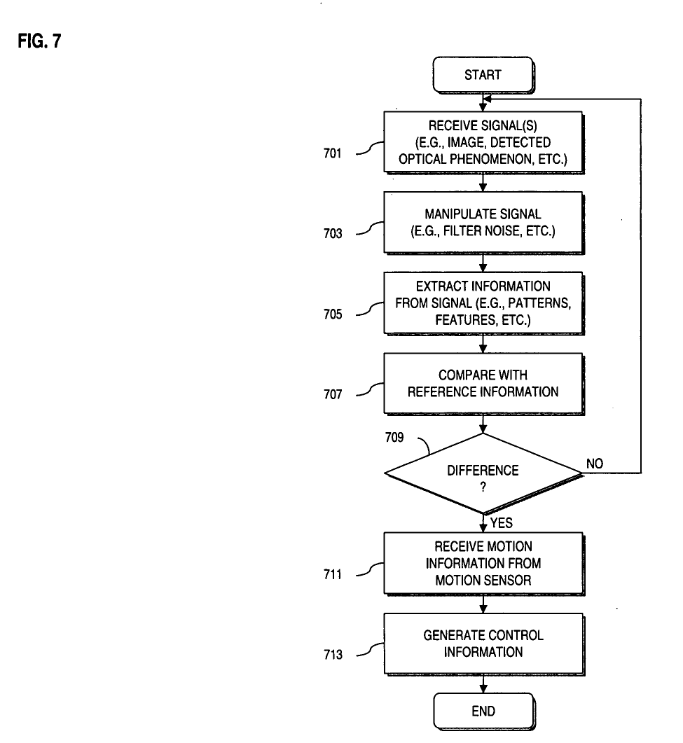

FIG. 6A is a flowchart of a process for controlling a function or updating a display of mobile communication device 100 based on motion of, for instance, optical input mechanism 200, according to an exemplary embodiment. At step 601, mobile communication device 100 executes an “optical input mechanism” application in response to user initialization for providing users with “joystick-like” input capabilities. That is, controller 125 implements instructions stored to memory 127 in response to user interaction with optical input mechanism 200. Operation of controller 125 provides a graphical interface to the user via display 115. The graphical interface may include one or more input fields, menus, options, selections, etc., that enables the user to input or otherwise interact with a function of mobile communication device 100. These fields, menus, options, selections, etc., can be manipulated or controlled via user actuation, i.e., motion, of optical input mechanism 200. Thus, per step 603, mobile communication device 100 (e.g., user interface module 137) monitors motion of optical input mechanism 200. Such motion may be monitored and, thereby, detected via one or more of sensors 111, e.g., optoelectronic sensor (e.g., optical sensor 227), accelerometer (e.g., accelerometer 245), etc., which may be assisted via one or more illumination sources 109 (e.g., illumination source 231). An exemplary process for detecting motion is described in more detail in accordance with FIG. 7. As such, in step 605, user interface module 137 determines whether motion of optical input mechanism 200 has been detected. If no motion has been detected, then user interface module 137 continues to monitor optical input mechanism 200. If motion has been detected, then user interface module 137 evaluates, per step 607, one or more properties governing the motion of control member 201 based on input from a motion sensor, such as accelerometer 241. Such properties may include a direction of motion, a speed of motion, an acceleration of motion, or a combination thereof. The motion may be a translational displacement of control member 201 or a rotational movement of control member 201. Based on evaluation, user interface module 137 determines, in step 609, “joystick-like movement” control information for control member 201. Generation of this “joystick-like movement” control information is also more fully explained in conjunction with FIG. 7. Based on this “joystick-like movement” control information, user interface module 137 via controller 125 can either control a function or update a display of mobile communication device 100, at step 611. It is noted that the motioning of optical input mechanism 200 by a user, and the functions and/or applications accessed by the user will govern whether controller 125 and/or user interface module 137 controls a function of or updates a display of mobile communication device 100.

FIG. 6B is a flowchart of a process for controlling a function or updating a display of mobile communication device 100 based on sensed motion of mobile communication device 100 by, for example, optical input mechanism 300, according to an exemplary embodiment. It is noted that the process is equally applicable to optical input mechanism 400. Furthermore, the process of FIG. 6B is similar to that of FIG. 6A; however, mobile communication device 100 (i.e., controller 125) implements an “optical mouse” application via an optical input mechanism 300. In this manner, user interface module 137 monitors motion of mobile communication device 100 along or about a resting surface (e.g., resting surface 313) instead of particularly monitoring the motion of optical input mechanism 200.

Thus, controller 125 executes an “optical mouse” application in response to user initialization, per step 651. That is, controller 125 implements instructions stored to memory 127 in response to user interaction with mobile communication device 100, e.g., the user moving mobile communication device 100 along or about resisting surface 313. According to certain embodiments, placement of mobile communication device 100 on resting surface 313 can implement the “optical mouse” application, which may then be executed upon motion of mobile communication device 100 along resisting surface 313. Placement and/or motioning events may be detected and or sensed via optical input mechanism 300 and/or one or more of sensors 111, such as accelerometer 245, proximity sensor, etc. In this manner, user interface module 137 via optical input mechanism 300 and/or sensors 111 monitors for motion of mobile communication device 100 along resisting surface 313. Per step 655, user interface module 137 determines whether motion has been detected. Again, an exemplary process for detecting motion is described in more detail in accordance with FIG. 7. If motion is not detected, then user interface module 137 continues to monitor for relative motion of mobile communication device 100 along resisting surface 313. If motion is detected, then user interface module 137 evaluates, per step 657, one or more properties governing the motion of mobile communication device 100 based on input from a motion sensor, such as accelerometer 241. Such properties may include a direction of motion, a speed of motion, an acceleration of motion, or a combination thereof. The motion may be a translational displacement of mobile communication device 100 on resting surface 313 or a rotational movement of mobile communication device 100 on resting surface 313. Based on evaluation, user interface module 137 determines, per step 659, “mouse-like movement” control information for mobile communication device 100. Generation of control information is also more fully explained in conjunction with FIG. 7. Based on this “mouse-like movement” control information, user interface module 137 via controller 125 can either control a function or update a display of mobile communication device 100, in step 661. It is noted that the motioning of optical input mechanism 300 by a user, and the functions and/or applications accessed by the user will govern whether controller 125 and/or user interface module 137 controls a function of or updates a display of mobile communication device 100.

FIG. 7 is a flowchart of a process for generating control information based on motion of an optical input mechanism, according to an exemplary embodiment. For purposes of explanation, the process is described with respect optical input mechanism 200 of FIG. 2 and the components of mobile communication device 100 of FIG. 1; however, the process is equally applicable to optical input mechanisms 300 and 400 of FIGS. 3 and 4, respectively.

In step 701, controller 125 (and/or user interface module 137) receives one or more signals from, for example, optical sensor 227. The signals may correspond to one or more images taken of bottom surface 201a of control member 201, detected optical phenomenon (e.g., sensed illumination, optical interference pattern, etc.), etc., ported to controller 125 via optical sensor 227. It is noted that optical sensor 227 may be enabled to detect, capture, or otherwise produce these signals based on radiation provided from illumination source 231 that is cast upon bottom surface 201a of control member 201 and reflected, scattered, etc., to and detected by optical sensor 227. The one or more signals are manipulated at step 703. That is, controller 125 reduces extraneous noise and/or information from the signals (e.g., images, interface pattern, etc.). For example, assuming the one or more signals correspond to images of the bottom surface 201a of control member 201, controller 125 may, via one or more conventional image processing techniques, such as convolving the image with a smoothing kernel, conforming neighboring image pixels to an intensity threshold or average, performing Gaussian filtering techniques or non-linear (e.g., median filter) methods, etc., manipulate (or otherwise clean up) the images corresponding to the one or more signals. Other conventional image processing or digital signal processing techniques, such as coloring, lens correction, sharpening or softening, orienting, transforming, phasing, filtering, etc., may also be performed via controller 125. Per step 705, controller 125 extracts reference information from the one or more signals, such as one or more patterns, features, interference patterns, etc. For example, if the one or more signals correspond to images, then based on a priori knowledge or on statistical information of the multidimensional surface being imaged (e.g., bottom surface 201a of control member 201), one or more patterns and/or features from the image may be extracted.

Utilizing the extracted information, controller 125 compares the information to or with reference information, per step 707. In the example of the images, the one or more patterns or features that are extracted can be compared with reference patterns or features. In other instances, controller 125 may compare the information extracted from a successively prior or relatively recent time interval. As such, controller 125 determines, in step 709, whether there is a difference between the extracted information of the one or more signals and the reference information. If no or not a substantial enough difference exists, optical sensor 227 continues monitor for motion of control member 201 and ports signals corresponding to sensed monition to controller 125. If enough of a difference is realized, then controller 125 receives, at step 711, motion information (e.g., direction, speed, acceleration, etc.) sensed via a motion sensor, such as accelerometer 241. Based on this information, controller 125 generates, per step 713, control information based on the nature and/or quality of the difference and/or based on the nature and/or quality of the sensed motion information. It is noted that the generation of control information is contingent upon the motioning of optical input mechanism 200 by a user, and the functions and/or applications accessed by the user.

According to one embodiment, a magnitude (or range of magnitudes) of the sensed motion (e.g., direction, speed, acceleration, etc.) can be utilized for generating differing levels of corresponding control information by controller 125, such as a predetermined response factor (or range of response factors). For instance, relatively small magnitudes detected by the motion sensor (e.g., accelerometer 241) corresponding to, for example, slow input movement of control member 201 by a user, can be utilized by controller 125 to generate a first response factor, such as one click of a conventional video game controller in a corresponding direction of input movement. Relatively large magnitudes detected by the motion sensor corresponding to, for example, fast input movement of control member 201 by the user, can be utilized by controller 125 to generate a second response factor, such as five clicks of a conventional video game controller in a corresponding direction of input movement. Depending on one or more predetermined ranges for the magnitudes of the relatively small magnitudes and the relatively large magnitudes, a middle magnitude range may be provided to correspond to, for instance, average input movement of control member 201 by the user. This average input may relate to a third response factor, such as three clicks of a conventional video game controller in a corresponding direction of input movement. It is contemplated, however, that any suitable number of magnitudes, ranges of magnitudes, response factors, range of response factors, corresponding number of “clicks,” etc., may be utilized and/or determined. It is further contemplated that a user may be provided with an opportunity to adjust these parameters via a graphical user interface of mobile communication device 100 that interfaces with a user profile stored to, for example, memory 127. In this manner, it is also contemplated that “angled” directional input movement of control member 201, e.g., combined motion in, for instance, both the imaginary X-direction and the imaginary Y-direction, may be combined with detected magnitude information to generate corresponding response factors, such as a predetermined number of clicks in the angled direction, i.e., a predetermined number of clicks in the imaginary X-direction and a predetermined number of clicks in the imaginary “Y” direction. Again, the magnitude (or range of magnitudes) of the sensed motion in the angled direction (or components thereof) can be utilized to generate differing levels (or ranges of levels) of response factors in the angled direction (or components thereof).

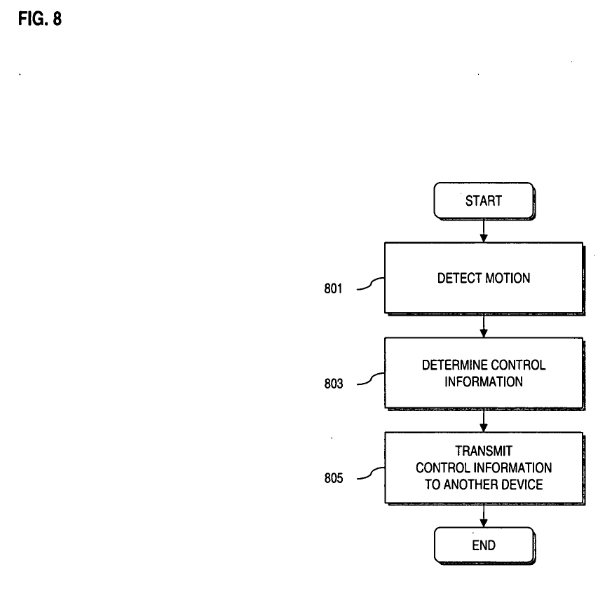

FIG. 8 is a flowchart of a process for transmitting control information to another device based on motion of an optical input mechanism, according to an exemplary embodiment. For the purposes of explanation, the process is described with respect to optical input mechanism 400 and the components of mobile communication device 100 of FIG. 1; however, it is contemplated that the process is equally applicable to optical input mechanisms 200 and 300. In step 801, user interface module 137 (and/or controller 125) detects motion of mobile communication device 100 relative to resting surface 313. That is, illumination source 231, backlight 405, etc., irradiates resting surface 313 so that optical sensor 227 can detect, image, or otherwise capture information corresponding to the motioning of mobile communication device 100 along or about resting surface 313. Utilizing the process of FIG. 7, controller 125 determines control information based on the detected motion, per step 803, for controlling a function of another or remote device or updating a display of the other or remote device. Thus, at step 805, user interface 137 (and/or controller 125) via transceiver 129 and antenna 131 and/or wireless controller 133 and antenna 135, transmits over one or more of the aforementioned networks, the control information to the other or remote device, such as a personal computer, robotic mechanism, etc.

While the disclosure has been described in connection with a number of embodiments and implementations, the disclosure is not so limited, but covers various obvious modifications and equivalent arrangements, which fall within the purview of the appended claims. Although features of the disclosure are expressed in certain combinations among the claims, it is contemplated that these features can be arranged in any combination and order.

What is claimed is:

1. A method comprising:
detecting motion of an input mechanism of a mobile communication device via an optical sensor;
evaluating, in response to detection, one or more properties governing the motion based on input from a motion sensor; and
generating control information based on evaluation.

2. A method as recited in claim 1, wherein the detecting step comprises:
physically manipulating an element of the mobile communication device; and
receiving illumination reflected from a surface of the mobile communication device.

3. A method as recited in claim 1, wherein the step of evaluating comprises detecting direction of motion.

4. A method as recited in claim 1, wherein the step of evaluating comprises detecting rate of motion.

5. A method as recited in claim 1, wherein the step of evaluating comprises detecting acceleration of motion.

6. A method as recited in claim 1, wherein the step of generating comprises determining a response factor with respect to the one or more properties.

7. A method as recited in claim 6, wherein the step of determining comprises retrieving user profile information from a memory of the mobile communication device.

8. A method as recited in claim 1, wherein the detecting step comprises sensing motion corresponding to translational displacement of the input mechanism.

9. A method as recited in claim 1, wherein the detecting step comprises sensing rotational movement of the input mechanism.

10. A method as recited in claim 1, further comprising:
transmitting the control information to another device; and
controlling the other device in accordance with the transmitted control information.

11. A mobile communication device, comprising:
an input mechanism;
a motion sensor;
an optical sensor; and
a processor,
wherein the optical sensor is configured to detect motion of the input mechanism, and the processor is configured to evaluate, in response to detection, one or more properties governing the motion based on input from the motion sensor and to generate control information based on evaluation.

12. A mobile communication device as recited in claim 11, further comprising:
an illumination source configured to illuminate a surface of mobile communication device,
wherein the optical sensor is configured to detect the motion by sensing illumination reflected by the surface.

13. A mobile communication device as recited in claim 11, wherein the motion sensor comprises an accelerometer.

14. A mobile communication device as recited in claim 11, wherein the motion sensor comprises an inertial sensor.

15. A mobile communication device as recited in claim 11, wherein the motion sensor comprises a vibrometer.

16. A mobile communication device as recited in claim 11, wherein the motion sensor comprises a gyroscope.

17. A mobile communication device as recited in claim 12, further comprising:
a memory configured to store user profile information relating to one or more motion response factors.

18. A mobile communication device as recited in claim 11, wherein the input mechanism comprises a user manipulable element.

19. A mobile communication device as recited in claim 11, further comprising:
a display;
wherein the control information is utilized to control a function of the mobile communication device or update a presentation of the display.

20. A mobile communication device as recited in claim 11, further comprising:
a communication interface configured to transmit the control information to another device,
wherein the control information is utilized to control the other device, control a function of the other device, or update a display of the other device.
